(19) United States
(12) Patent Application Publication
(10) Pub. No.: US 2021/0334210 A1
(43) Pub. Date: Oct. 28, 2021

(54) METHOD AND NETWORK DEVICE FOR PROCESSING SERVICE DATA

(71) Applicant: WANGSU SCIENCE & TECHNOLOGY CO., LTD., Shanghai (CN)

(72) Inventors: Jiaxuan XU, Shanghai (CN); Zhiwen CAO, Shanghai (CN)

(21) Appl. No.: 16/330,205

(22) PCT Filed: Apr. 2, 2018
(86) PCT No.: PCT/CN2018/081555

§ 371 Date: Mar. 4, 2019

(30) Foreign Application Priority Data
Mar. 13, 2018 (CN) 201810205185.8

(51) Int. Cl. G06F 12/06; G06F 13/40; G06F 9/455

(52) U.S. Cl. CPC G06F 12/0646; G06F 13/4022; G06F 2009/45595; G06F 2212/152; G06F 2009/45583; G06F 9/45558

(57) ABSTRACT

The present invention discloses a method and a network device for processing service data and relates to the technical field of virtualization. The method includes: calling a Virtio to establish a communication connection with a Vhost deployed on a virtual switch when a first processing progress starts; applying for a target storage space by the first processing progress and dividing the target storage space into a plurality of sub-storage spaces; and determining a target sub-storage space in the plurality sub-storage spaces and processing the service data based on the target sub-storage space when a second processing progress starts. The present disclosure may save processing resources of a network device and ensure the efficiency of processing the service data.

### FIELD OF THE DISCLOSURE

The present disclosure generally relates to the technical field of virtualization and, more particularly, relates to a method and a network device for processing service data.

### BACKGROUND

Vhost/Virtio technology provides a para-virtualized device abstract interface specification. DPDK (Data Plane Development Kit) framework mostly utilizes the Vhost/Virtio for the transmission and reception of service data. In the projects of DPDK technical transformation, there may be a plurality of virtual processing progresses which simultaneously process the transmitted and received service data, and each processing progress may implement data exchange with a physical network interface card (NIC) through the Vhost/Virtio.

As an example, a protocol stack in a processing progress may encapsulate and decapsulate service data based on a multi-layer communication protocol in a network. In order to save CPU interrupt time and data reading time during the process of service data resolution by a CPU kernel protocol stack, technicians may utilize DPDK to modify the processing progress. After the physical NIC receives the service data, the NIC driver reloaded by the DPDK framework does not notify the CPU through an interrupt request, instead, the service data are directly copied to an application layer and then the service data are decapsulated through a separate protocol stack.

In the process of implementing the present invention, the inventors have found that the conventional technology has at least the following problems.

The Vhost only allows one processing progress to call the Virtio to establish a communication connection at a time. A plurality of processing progresses need to alternatively call the Virtio and the Vhost frequently to establish communication connections which may implement the transmission and reception of the service data. Thus, the processing resources of network devices are greatly wasted, and the efficiency of processing service data is reduced.

### BRIEF SUMMARY OF THE DISCLOSURE

To solve the problems in the existing technology, embodiments of the present invention provide a method and a network device for processing service data. The technical solution is the following.

One aspect of the present invention provides a method for processing service data. The method includes: calling a Virtio to establish a communication connection with a Vhost deployed in a virtual switch when a first processing progress starts; applying for a target storage space by the first processing progress and dividing the target storage space into a plurality of sub-storage spaces; and determining a target sub-storage space in the plurality sub-storage spaces and processing the service data based on the target sub-storage space when a second processing progress starts.

Optionally, the processing of the service data based on the target sub-storage space includes: periodically detecting the target sub-storage space by the second processing progress; and if the target sub-storage space contains service data to-be-processed, acquiring the service data to-be-processed and processing the service data to-be-processed by the second processing progress.

Optionally, the method further includes: acquiring the service data to-be-processed from a physical network interface card by the virtual switch; and determining current loads of all processing progresses by the virtual switch and storing the service data to-be-processed into a sub-storage space corresponding to a processing progress with a lowest current load.

Optionally, the processing of the service data based on the target sub-storage space includes: acquiring the service data to-be-processed and processing the service data to-be-processed by the second processing progress; and storing the processed service data into the target sub-storage space by the second processing progress.

Optionally, the method further includes: if a target sub-storage space in the plurality of sub-storage spaces is detected storing the processed service data, extracting the processed service data by the virtual switch and providing the processed service data to the physical NIC.

Optionally, applying for the target storage space by the first processing progress and dividing the target storage space into a plurality of sub-storage spaces includes: reading a preset configuration file by the first processing progress and determining a total number of processing progresses; and applying for the target storage space by the first processing progress and dividing the target storage space into a plurality of sub-storage spaces according to the total number of the processing progresses.

Optionally, the method further includes: performing a data negotiation with the Vhost to generate a negotiation result by the first processing progress; setting a shared sub-storage space in the plurality of sub-storage spaces and storing the negotiation result in the shared sub-storage space by the first processing progress; and after determining the target sub-storage space by the second processing progress, accessing the shared sub-storage space to acquire the stored negotiation result and initializing the target sub-storage space based on the negotiation result.

Another aspect of the present invention provides a network device for processing service data. The network device is configured with a virtual switch and performs a plurality of processing progresses, where: a first processing progress of the plurality of processing progresses is configured to call a Virtio to establish a communication connection with a Vhost deployed on a virtual switch when the first processing progress starts; the first processing progress is configured to apply for a target storage space and divides the target storage space into a plurality of sub-storage spaces; and a second processing progress of the plurality of processing progresses is configured to determine a target sub-storage space in the plurality of sub-storage spaces and process the service data based on the target sub-storage space when the second processing progress starts.

Optionally, the second processing progress is configured to: periodically detect the target sub-storage space; and if the target sub-storage space contains the service data to-be-processed, acquire the service data to-be-processed and process the service data to-be-processed.

Optionally, the network device is configured with a physical NIC, where: the virtual switch is configured to acquire the service data to-be-processed received by the physical NIC, determine the current loads of all processing progresses, and store the service data to-be-processed into the sub-storage space according to the processing progress with the lowest current load.

Optionally, the second processing progress is configured to: acquire the service data to-be-processed and process the service data to-be-processed; and store the processed service data into the target sub-storage space.

Optionally, the network device is configured with a physical NIC, where: if a target sub-storage space in the plurality of sub-storage spaces is detected storing the processed service data, the virtual switch extracts the processed service data and provides the processed service data to the physical NIC.

Optionally, the first processing progress is configured to: read a preset configuration file and determine the total number of the processing progresses; and apply for a target storage space and divide the target storage space into a plurality of sub-storage spaces according to the total number of the processing progresses.

Optionally, the first processing progress is configured to perform a data negotiation with the Vhost to generate a negotiation result; and set a shared sub-storage space in the plurality of sub-storage spaces and store the negotiation result in the shared sub-storage space; and the second processing progress is configured to determine the target sub-storage space, and access the shared sub-storage space to acquire the stored negotiation result and initialize the target sub-storage space based on the negotiation result.

The beneficial effects of the technical solution provided by embodiments of the present invention are: in embodiments of the present invention, when the first processing progress starts, it calls the Virtio to establish a communication connection with the Vhost deployed in the virtual switch; the first processing progress applies for the target storage space and divides the target storage space into a plurality of storage spaces; when the second processing progress starts, it determines the target sub-storage space in the plurality of sub-storage spaces and processes the service data based on the target sub-storage space. In such way, a processing progress calls the Virtio to establish a communication connection with the Vhost interface, and a plurality of processing progresses use the above same communication connection to implement the transmission and reception of the service data through the shared storage space method. There is no need to use the plurality of processing progresses to call the Virtio alternatively to establish the communication connection with the Vhost interface, so that processing resources of the network device is saved and the efficiency of processing the service data is ensured.

### BRIEF DESCRIPTION OF THE DRAWINGS

To more clearly illustrate the technical solutions of the present disclosure, the accompanying drawings to be used in the description of the disclosed embodiments are briefly described hereinafter. Obviously, the drawings described below are merely some embodiments of the present disclosure. Other drawings derived from such drawings may be obtained by a person having ordinary skill in the art without creative labor.

FIG. 1 illustrates a frame diagram of processing service data according to embodiments of the present disclosure;

FIG. 2 illustrates a flowchart of a method for processing service data according to embodiments of the present disclosure;

FIG. 3 illustrates a structural schematic of a shared storage space according to embodiments of the present disclosure; and

FIG. 4 illustrates a structural schematic of a network device according to embodiments of the present disclosure.

### DETAILED DESCRIPTION

To more clearly describe the objectives, technical solutions and advantages of the present invention, the present invention is further illustrated in detail with reference to the accompanying drawings in conjunction with embodiments.

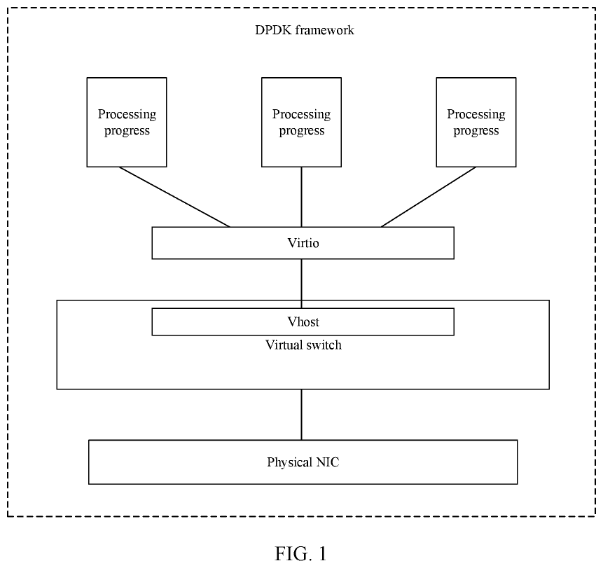

Embodiments of the present invention provide a method for processing service data. The execution entity of the method may be a network device, and the network device may be any devices with data transmission and reception functions such as a computer or a server. The network device may execute a project progress and a plurality of processing progresses having at least one network service. Each processing progress may be used to process the service data of the project progress. The processing may be the resolution of the service data (including encapsulation and decapsulation) as mentioned in the background section or may be other data processing. The network device may utilize DPDK technology to implement the above virtualization process and support DPDK framework to set up a virtual switch. One end of the virtual switch may be connected to the physical NIC of a network device and another end may exchange data with the processing progresses through the Vhost/Virtio interface. The Vhost/Virtio under the DPDK framework has high performance on data throughput and may serve a plurality of processing progresses described above. Each processing progress may implement data exchange with the physical NIC through the Vhost/Virtio interface, and thus implement the transmission and reception of service data, where the specific frame diagram refers to FIG. 1. The network device may include a processer, a memory and a transceiver. The processor may be used to process service data in the following processes, and the memory may be used to store required data and the generated data in the following processes, and the transceiver may be used to receive and transmit relevant data in the following processes. In this embodiment, the resolution process of the service data is used as an example for description, and other processing procedures are similar and are not described in detail.

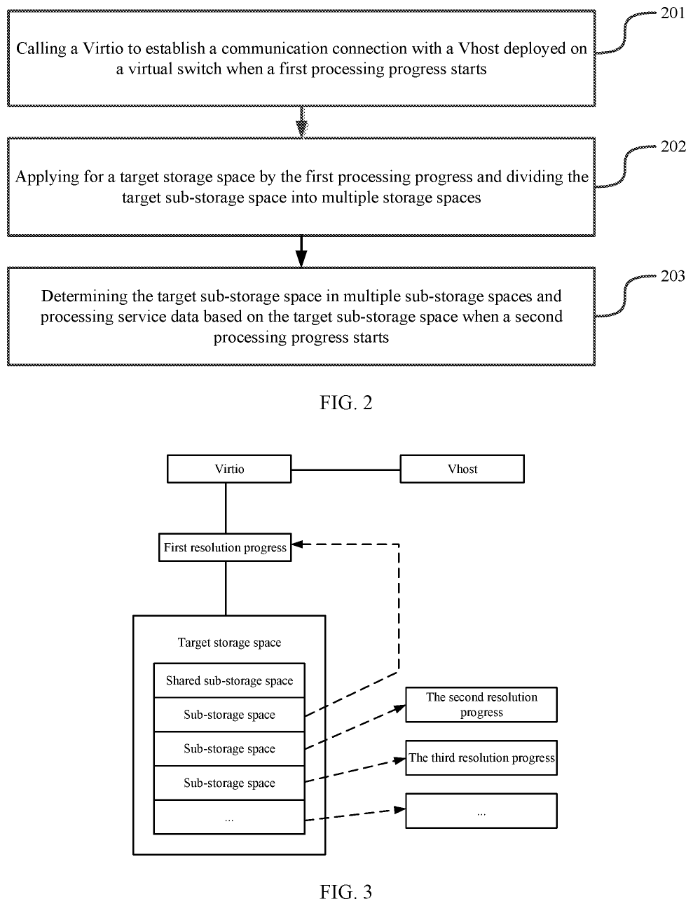

The process flow described in FIG. 2 is illustrated in detail using the resolution of the service data as an example in conjunction with specific embodiments. The content may be the following.

Step 201, when the first processing progress starts, the Virtio is called to establish a communication connection with the Vhost deployed in the virtual switch.

In the scenario of the service data resolution, the processing progress may be independently executed on the CPU of the network device, which may have the function of protocol stack. The independent protocol stack may be developed by technicians on the network device side and may be different from the original kernel protocol stack on the CPU.

In one embodiment, when the first (or primary) processing progress starts, whether the first processing progress itself is the primary (first started) data processing progress may be determined. If it is determined that the first processing progress itself is the primary data processing progress, the initialization process may be executed. Specifically, the Virtio of the virtual NIC may be called to establish a linux domain socket communication connection with the Vhost deployed in the virtual switch. If the first processing progress is not the primary processing progress, the following step 203 may be used as a reference to search the corresponding sub-storage space. It should be noted that, technicians may pre-specify the processing progress of calling Virtio to establish a communication connection with the Vhost interface. Then the specified result is recorded to a configuration file and the configuration file is loaded into the network device. In such way, the first processing progress may search the above configuration file after its start to determine whether to call the Virtio to establish a communication connection with the Vhost interface.

Step 202, the first processing progress applies for a target storage space and divides the target storage space into a plurality of sub-storage spaces.

In one embodiment, after the first processing progress calls the Virtio to establish a communication connection with the Vhost interface, a shared structure may be created, that is, a target storage space is applied for from the operating system of the network device and the target storage space may be a shared storage space for a plurality of processing progresses. Further, the first processing progress may divide the target storage space into a plurality of sub-storage spaces and each sub-storage space may be provided to one processing progress to store the service data. Next, each processing progress may correspond to unique identification information, and the first processing progress may label each sub-storage space according to the identification information when the first processing progress is dividing sub-storage space. It should be understood that, the first processing progress may also be used to process the service data as well, so the sub-storage space corresponding to the first processing progress also exists in the target storage space. It is worth mentioning that each sub-storage space may be further divided into two parts, one part is used to store received service data to-be-decapsulated and another part is used to store the encapsulated service data to be transmitted.

Optionally, the first processing progress may create a plurality of sub-storage spaces according to the total number of processing progresses. Correspondingly, the processing of step 202 may be the following: reading the preset configuration file to determine the total number of processing progresses by the first processing progress; and applying for a target storage space by the first processing progress and dividing the target storage space into a plurality of sub-storage spaces according to the total number of processing progresses.

In one embodiment, technicians may record the total number of processing progresses running on the network device into a configuration file in advance, and then store the configuration file into the network device. In such way, when the first processing progress creates the shared structure, the preset configuration file may be read first to determine the total number of the processing progresses on the network device. Further, the first processing progress may divide the target storage space into a plurality of sub-storage spaces after applying the target storage space from the operating system of the network device, so that the number of the sub-storage spaces is as same as the total number of the processing progresses. In addition, technicians may preset the size of each sub-storage space and write it into the configuration file. In such way, based on the size of each sub-storage space and the total number of the processing progresses, the first processing progress may apply for the target storage space with corresponding size from the operating system of the network device.

Step 203, when the second processing progress starts, it may determine the target sub-storage space in the plurality of sub-storage spaces and perform the service data processing based on the target sub-storage space.

The second processing progress is any processing progress which is different from the first processing progress.

In one embodiment, after the second processing progress starts, it may search the shared structure created by the first processing progress. Specifically, the default identification information may be set for the shared structure when the first processing progress creates the shared structure, so that the second processing progress may find the shared structure according to the default identification information. Further, the second processing progress may determine the target sub-storage space labeled with the identification information of the second processing progress from the plurality of sub-storage spaces in the shared structure according to the identification information of the second processing progress. In such way, the second processing progress may process the service data based on the target sub-storage space. It can be understood that, based on the above processing, each processing progress may process the service data according to a sub-storage space in the target storage space.

Optionally, the processing progresses of service data based on the sub-storage space may be mainly divided into the reception phase of service data and the transmission phase of service data. The specific content may be the following respectively.

First, in the reception phase of service data: the second processing progress periodically detects the target sub-storage space; and if the target sub-storage space has the service data to-be-processed, the second processing progress acquires the service data to-be-processed and processes the service data to-be-processed.

In one embodiment, after each processing progress starts, it may acquire the service data to-be-processed (to-be-decapsulated) through the corresponding sub-storage space. Specifically, using the second processing progress as an example, after the second processing progress starts, it may periodically detect the target sub-storage space. If the target sub-storage space has the service data to-be-decapsulated, the second processing progress may extract the service data to-be-decapsulated and then decapsulate the service data to-be-decapsulated. Further, the second processing progress may provide the decapsulated service data to the corresponding project progress.

Optionally, the above service data to-be-processed may be that the virtual switch reads from the physical NIC and writes to the sub-storage space and the specific processing may be the following: acquiring the service data to-be-processed from the physical NIC by the virtual switch; and determining current loads of all processing progresses by the virtual switch and storing the service data to-be-processed into a sub-storage space corresponding to the processing progress with the lowest current load.

In one embodiment, after the external transmits the service data of a project progress to the network device, the physical NIC of the network device may receive the corresponding service data. In the scenario of the service data resolution, the service data may be the service data to-be-decapsulated after the encapsulation through multi-layer network communication protocol. Then, the virtual switch may acquire the service data to-be-decapsulated received by the physical NIC and determine the current loads of all processing progresses according to the current data size to-be-processed of each processing progress. Further, the virtual switch may select the processing progress with the lowest current load and store the service data to-be-decapsulated into the sub-storage space corresponding to the processing progress. If a plurality of processing progresses with the current load tied to the lowest exist, the virtual switch may randomly select a processing progress.

Second, in the transmission phase of service data: the second processing progress acquires the service data to-be-processed and processes the service data to-be-processed; and the second processing progress stores the processed service data into the target sub-storage space.

In one embodiment, the service data may be first provided to a processing progress for processing (encapsulation) when the project progress on the network device needs to transmit the service data to the external. Taking the second processing progress as an example, after the second processing progress acquires the service data to be encapsulated which is provided by the project progress, and may encapsulate the service data to be encapsulated. It is not difficult to think that if there are a plurality of processing progresses on the network device serving the above project progress, the project progress may select the processing progress with the lowest load from the plurality of processing progresses to process the service data based on the load balancing. After the second processing progress encapsulates the service data to be encapsulated, it may store the encapsulated service data into the corresponding target sub-storage space.

Optionally, the virtual switch may provide the processed service data in each sub-storage space to the physical NIC of the network device for sending and the specific processing may be the following: if a target sub-storage space in the plurality of sub-storage spaces is detected storing the processed service data, extracting the processed service data by the virtual switch and providing the processed service data to the physical NIC.

In one embodiment, after the first processing progress creates the target storage space, it may send the access address of the target storage space to the virtual switch. In such way, the virtual switch may periodically and orderly query whether the processed (encapsulated) service data is stored in the plurality of sub-storage spaces according to the access address of the target storage space. If the target sub-storage space in the plurality of sub-storage spaces is detected storing the encapsulated service data, the virtual switch may extract the encapsulated service data and then provide the encapsulated service data to the physical NIC on the network device, so that the physical NIC may transmit the encapsulated service data to the designated network address. In another case, the virtual switch may receive the corresponding prompt information when the target sub-storage space stores the service data to be encapsulated. Meanwhile, the virtual switch may also detect that encapsulated service data is stored in the target sub-storage space and may perform a subsequent processing.

In summary, on the one hand, the progress of processing received service data by the network device may be the following: the physical NIC receives the service data and the virtual switch acquires the service data, the service data is written in the sub-storage space though the Vhost/Virtio interface, the processing progress extracts the service data from the sub-storage space and processes the service data, the processed service data is provided to the project progress. On the other hand, the progress of processing service data to be transmitted by the network device may be the following: the processing progress acquires the service data to be transmitted from the project progress, and also processes the service data and stores the service data in the sub-storage space, and then the virtual switch read the service data in the sub-storage space through the Vhost/Virtio and the service data is transmitted by the physical NIC.

Optionally, the first processing progress performs a data negotiation with the Vhost to generate a negotiation result; the first processing progress set a shared sub-storage space in the plurality of sub-storage spaces and store the negotiation result in the shared sub-storage space; and after determining the target sub-storage space by the second processing progress, the second processing progress accesses the shared sub-storage space to acquire the stored negotiation result and initializes the target sub-storage space based on the negotiation result.

In one embodiment, the first processing progress calls the Virtio to establish a communication connection with the Vhost deployed on the virtual switch, and may also perform a data negotiation with the Vhost to generate a negotiation result, and the negotiation result may include underlying hardware characteristics of the network device and the parameter information of the target storage space (such as the size of target storage space, the access address and the number of the sub-storage spaces etc.). After the first processing progress divides the target storage space into a plurality of sub-storage spaces, it may set a shared sub-storage space in the plurality of sub-storage spaces, and then may store the above negotiation result in the shared sub-storage space. The structure of the target storage space may be shown in FIG. 3. Further, after the processing progress determines the sub-storage spaces respectively, it may first access the above shared sub-storage space, acquire the stored negotiation result, and perform an initialization process on the target sub-storage space based on the negotiation result.

In embodiments of the present invention, when the first processing progress starts, it calls the Virtio to establish a communication connection with the Vhost deployed in the virtual switch; the first processing progress applies for the target storage space and divides the target storage space into a plurality of storage spaces; when the second processing progress starts, it determines the target sub-storage space in the plurality of sub-storage spaces and processes the service data based on the target sub-storage space. In such way, a processing progress calls the Virtio to establish a communication connection with the Vhost interface, and a plurality of processing progresses use the above same communication connection to implement the transmission and reception of the service data through the shared storage space method. There is no need to use the plurality of processing progresses to call the Virtio alternatively to establish the communication connection with the Vhost interface, so that processing resources of the network device is saved and the efficiency of processing the service data is ensured.

Based on the same technical concept, embodiment of the present invention further provides a network device for processing service data, and the network device is configured with a virtual switch and performs a plurality of processing progresses, where:

The first processing progress of the plurality of processing progresses is configured to call a Virtio to establish a communication connection with a Vhost deployed on the virtual switch when the first processing progress starts;

The first processing progress is configured to apply for a target storage space and divide the target storage space into a plurality of sub-storage spaces; and

The second processing progress of the plurality of processing progresses is configured to determine a target sub-storage space in the plurality of sub-storage spaces and process the service data based on the target sub-storage space when the second processing progress starts.

Optionally, the second processing progress is configured to: periodically detect the target sub-storage space; and if the target sub-storage space has service data to-be-processed, acquire the service data to-be-processed and process the service data to-be-processed.

Optionally, the network device is configured with a physical NIC, where: the virtual switch is configured for acquiring the service data to-be-processed received by the physical NIC, determining the current loads of all processing progresses, and storing the service data to-be-processed into the sub-storage space according to the processing progress with the lowest current load.

Optionally, the second processing progress is configured to: acquire the service data to-be-processed and process the service data to-be-processed; and store the processed service data into the target sub-storage space.

Optionally, the network device is configured with a physical NIC, where: if a target sub-storage space in the plurality of sub-storage spaces is detected storing the processed service data, the virtual switch extracts the processed service data and provides the processed service data to the physical NIC.

Optionally, the first processing progress is configured to: read a preset configuration file and determine the total number of the processing progresses; and apply for a target storage space and divide the target storage space into a plurality of sub-storage spaces according to the total number of the processing progresses.

Optionally, the first processing progress is configured to perform a data negotiation with the Vhost to generate a negotiation result; set a shared sub-storage space in the plurality of sub-storage spaces and store the negotiation result in the shared sub-storage space using the first processing progress; and after determining the target sub-storage space, the second processing progress is configured to access the shared sub-storage space to acquire the stored negotiation result and initialize the target sub-storage space based on the negotiation result.

In embodiments of the present invention, when the first processing progress starts, it calls the Virtio to establish a communication connection with a Vhost deployed on the virtual switch; the first processing progress applies for a target storage space and divides the target storage space into the plurality of sub-storage spaces; when the second processing progress starts, it determines a target sub-storage space in the plurality of sub-storage spaces and processes the service data based on the target sub-storage space. In such way, a processing progress calls the Virtio to establish a communication connection with the Vhost interface, and the plurality of processing progresses use the above same communication connection to implement the transmission and reception of the service data through the shared storage space method. There is no need to use the plurality of processing progresses to call the Virtio alternatively to establish the communication connection with the Vhost interface, so that processing resources of the network device is saved and the efficiency of processing the service data is ensured.

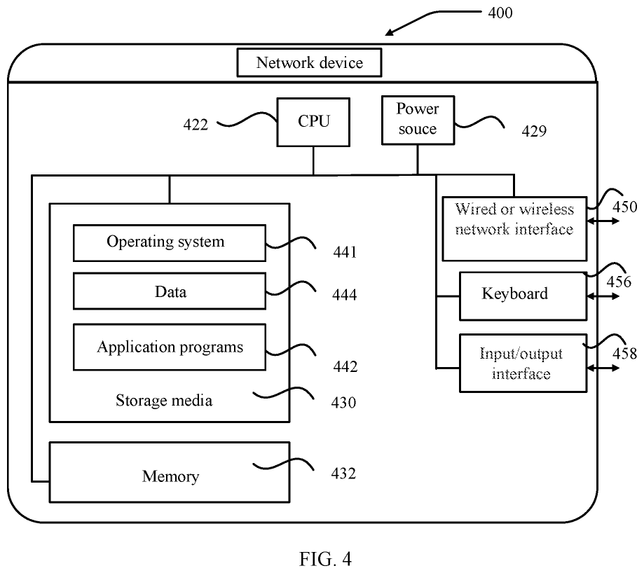

FIG. 4 illustrates a structural schematic of a network device according to embodiments of the present invention. The network device 400 may vary considerably depending on different configurations and performances, and may include one or more central processing units 422 (for example, one or more processors) and memories 432, one or more storage media 430 (for example, one or more mass storage devices) that store application programs 442 or data 444. The memory 432 and the storage media 430 may be temporary storage or permanent storage. Programs stored on the storage media 430 may include one or more modules (not shown in the figure) and each module may include a series of instructions and operations on the network device. Further, the central processing unit 422 may be configured to communicate with the storage media 430 and execute a series of instructions and operations in the storage media 430 on the network device 400.

The network device 400 may also include one or more power sources 429, one or more wired or wireless interfaces 450, one or more input and output interfaces 458, one or more keyboards 456, and/or one or more operating systems 441 such as Windows Server™, Mac OS XTM, Unix™, Linux™, FreeBSD™ etc.

The network device 400 may also include a memory, one or more programs where one or more programs are stored in the memory and are configured to execute instructions of processing the above service data which are included in one or more programs through one or more processors.

Those skilled in the art may clearly understand that all or part of steps of embodiments may be implemented by means of hardware or may be implemented by programs to instruct related hardware. The programs may be stored in computer readable storage media. The storage media may be read-only memory, magnetic disks or optical disks etc.

The foregoing is merely some preferred embodiments of the present disclosure, and is not intended to limit the protection scope of the present disclosure. Without departing from the spirit and principles of the present disclosure, any modifications, equivalent substitutions, and improvements, etc. shall fall within the scope of the present disclosure.

What is claimed is:

1. A method for processing service data, comprising:
calling a Virtio to establish a communication connection with a Vhost deployed on a virtual switch when a first processing progress starts;
applying for a target storage space by the first processing progress and dividing the target storage space into a plurality of sub-storage spaces; and
determining a target sub-storage space in the plurality sub-storage spaces and processing the service data based on the target sub-storage space when a second processing progress starts.

2. The method according to claim 1, wherein the processing of the service data based on the target sub-storage space includes:
periodically detecting the target sub-storage space by the second processing progress; and
if the target sub-storage space contains service data to-be-processed, acquiring the service data to-be-processed and processing the service data to-be-processed by the second processing progress.

3. The method according to claim 2, wherein the method further includes:
acquiring the service data to-be-processed from a physical network interface card (NIC) by the virtual switch; and
determining current loads of all processing progresses by the virtual switch and storing the service data to-be-processed into a sub-storage space corresponding to a processing progress with a lowest current load.

4. The method according to claim 1, wherein the processing of the service data based on the target sub-storage space includes:
acquiring the service data to-be-processed and processing the service data to-be-processed by the second processing progress; and
storing the processed service data into the target sub-storage space by the second processing progress.

5. The method according to claim 4, wherein the method further includes:
if a target sub-storage space in the plurality of sub-storage spaces is detected storing the processed service data, extracting the processed service data by the virtual switch and providing the processed service data to the physical NIC.

6. The method according to claim 1, wherein applying for the target storage space by the first processing progress and dividing the target storage space into a plurality of sub-storage spaces includes:
reading a preset configuration file by the first processing progress and determining a total number of processing progresses; and
applying for the target storage space by the first processing progress and dividing the target storage space into the plurality of sub-storage spaces according to the total number of the processing progresses.

7. The method according to claim 1, wherein the method further includes:
performing a data negotiation with the Vhost to generate a negotiation result by the first processing progress;
setting a shared sub-storage space in the plurality of sub-storage spaces and storing the negotiation result in the shared sub-storage space by the first processing progress; and
after determining the target sub-storage space by the second processing progress, accessing the shared sub-storage space to acquire the stored negotiation result and initializing the target sub-storage space based on the negotiation result.

8. A network device for processing service data, wherein the network device is configured with a virtual switch and performs a plurality of processing progresses, wherein:
a first processing progress of the plurality of processing progresses is configured to call a Virtio to establish a communication connection with a Vhost deployed on the virtual switch when the first processing progress starts;
the first processing progress is configured to apply for a target storage space and divides the target storage space into a plurality of sub-storage spaces; and
a second processing progress of the plurality of processing progresses is configured to determine a target sub-storage space in the plurality of sub-storage spaces and process the service data based on the target sub-storage space when the second processing progress starts.

9. The network device according to claim 8, wherein the second processing progress is configured to:
periodically detect the target sub-storage space; and
if the target sub-storage space contains the service data to-be-processed, acquire the service data to-be-processed and process the service data to-be-processed.

10. The network device according to claim 9, wherein the network device is configured with a physical NIC, wherein:
the virtual switch is configured to acquire the service data to-be-processed received by the physical NIC, determine the current loads of all processing progresses, and store the service data to-be-processed into the sub-storage space according to the processing progress with the lowest current load.

11. The network device according to claim 8, wherein the second processing progress is configured to:
acquire the service data to-be-processed and process the service data to-be-processed; and
store the processed service data into the target sub-storage space.

12. The network device according to claim 11, wherein the network device is configured with a physical NIC, wherein:
if a target sub-storage space in the plurality of sub-storage spaces is detected storing the processed service data, the virtual switch extracts the processed service data and provides the processed service data to the physical NIC.

13. The network device according to claim 8, wherein the first processing progress is configured to:
read a preset configuration file and determine the total number of the processing progresses; and
apply for a target storage space and divide the target storage space into a plurality of sub-storage spaces according to the total number of the processing progresses.

14. The network device according to claim 8, wherein:
the first processing progress is configured to perform a data negotiation with the Vhost to generate a negotiation result using, and set a shared sub-storage space in the plurality of sub-storage spaces and store the negotiation result in the shared sub-storage space using the first processing progress; and
after determining the target sub-storage space, the second processing progress is configured to access the shared sub-storage space to acquire the stored negotiation result and initialize the target sub-storage space based on the negotiation result.
